(19) United States
(12) Patent Application Publication
(10) Pub. No.: US 2014/0201354 A1
(43) Pub. Date: Jul. 17, 2014

(54) NETWORK TRAFFIC DEBUGGER

(71) Applicant: BROADCOM CORPORATION, Irvine, CA (US)

(72) Inventors: Brad Matthews, San Jose, CA (US); Puneet Agarwal, Cupertino, CA (US); Bruce Kwan, Sunnyvale, CA (US)

(73) Assignee: BROADCOM CORPORATION, Irvine, CA (US)

(21) Appl. No.: 13/743,780

(22) Filed: Jan. 17, 2013

(51) Int. Cl. H04L 12/26

(52) U.S. Cl. CPC H04L 43/0876
USPC 709/224

(57) ABSTRACT

Disclosed are various embodiments that relate to a network switch. The switch determines whether a network packet is associated with a packet processing context, the packet processing context specifying a condition of handling network packets processed in the switch. The switch determines debug metadata for the network packet in response to the network packet being associated with the packet processing context; and the debug metadata is stored in a capture buffer.

### BACKGROUND

A collection of servers may be used to create a distributed computing environment. The servers may process multiple applications by receiving data inputs and generating data outputs. Network switches may be used to route data from various sources and destinations in the computing environment. For example, a network switch may receive network packets from one or more servers and/or network switches and route the network packets to other servers and/or network switches. Accordingly, network traffic may flow at varying rates through the network switches. It may be the case that a particular set of network switches experiences a disproportionate amount of network traffic congestion with respect to other network switches.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a computing environment, according to various embodiments of the present disclosure.

FIG. 2 is a drawing of an example of a network switch implemented in the computing environment of FIG. 1, according to various embodiments of the present disclosure.

FIG. 3 is a drawing of an example of a network status message generated by a network switch in the computing environment of FIG. 1, according to various embodiments of the present disclosure.

FIG. 4 is a flowchart illustrating one example of functionality implemented as portions of the processing circuitry in the network switch in the computing environment of FIG. 1, according to various embodiments of the present disclosure.

FIG. 5 is a flowchart illustrating another example of functionality implemented as portions of the processing circuitry in the network switch in the computing environment of FIG. 1, according to various embodiments of the present disclosure.

FIG. 6 is a flowchart illustrating another example of functionality implemented as portions of the processing circuitry in the network switch in the computing environment of FIG. 1, according to various embodiments of the present disclosure.

### DETAILED DESCRIPTION

The present disclosure relates to obtaining information from one or more switches in a network to assist in monitoring/debugging network traffic. Various network switches in the computing environment are configured to determine one or more network state metrics associated with network traffic congestion of the network switch. A network state metric may express the status of a particular network switch. A network state metric may also express network traffic attributes. For example, the network state metric may be an average delay, max delay, etc. Additionally, network switches may determine packet specific metadata to assist in monitoring/debugging particular network packets. For example, metadata may be generated for those packets that have been dropped by a network switch. This metadata may provide information relating to the circumstances surrounding the dropping of a packet.

According to various embodiments, a network switch includes a capture buffer for accumulating network state metrics and/or packet specific metadata. A user may submit a read request to the network switch to read the information stored in the capture buffer. Alternatively, the network switch may automatically send out a network status message to a network state monitor. The network status message may include the network state metric and/or packet specific metadata. The network status message may communicate device specific information such as power consumption by the network switch, buffer fill levels, single hops delays, or any other device specific items. Furthermore, the network status message may communicate packet specific information such as individual packet delays, individual local ports of a dropped network packet, etc.

In the case where multiple network switches are employed in a computing environment, a network state monitor may receive network status messages from each participating network switch. The network state manager may build a map or global snapshot based on the network status messages received from each network switch. For example, the global snapshot may provide a coherent view of the computing environment to identify root causes related to traffic flow and resource allocation issues in the computing environment.

In various embodiments of the present disclosure, each network switch reports one or more network state metrics associated with the respective network switch. Furthermore, each network switch may be configured to report a corresponding network state metric according to a time synchronizing protocol. For example, each network switch may be synchronized to a reference clock. Accordingly, each transmission of a network status message is synchronized with network status messages transmitted by other network switches in the computing environment. Thus, a network state monitor may receive synchronized network status messages from each of the networks switches in order to generate a global snapshot of the computing environment.

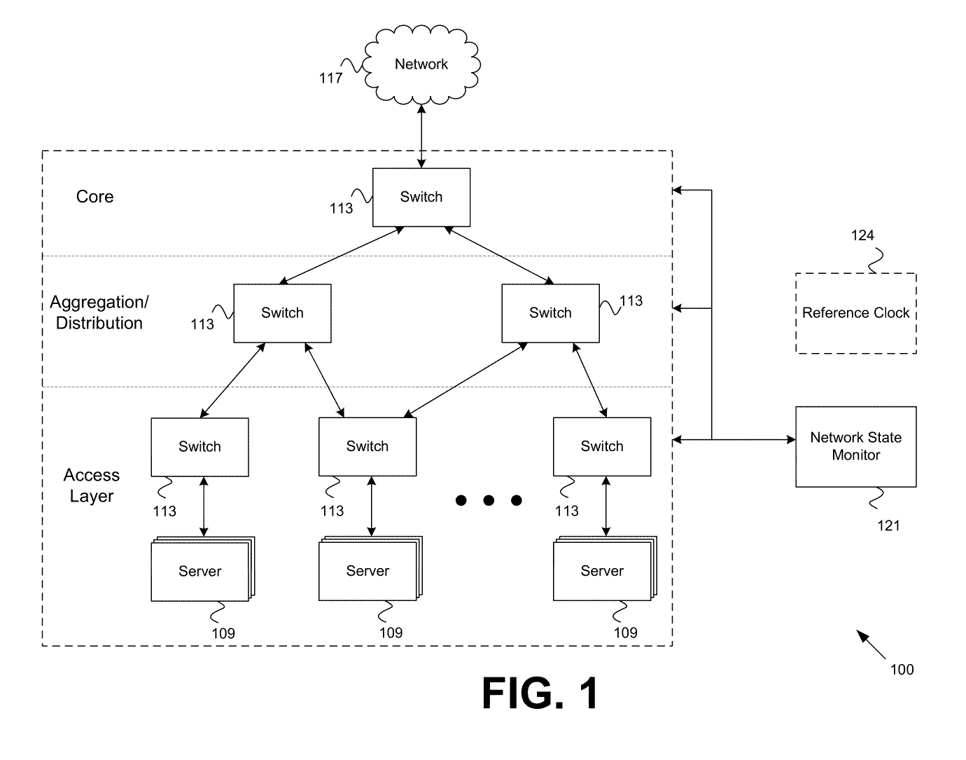

With reference to FIG. 1, shown is a computing environment 100. The computing environment 100 may comprise a private cloud, a data warehouse, a server farm, or any other collection of computing devices that facilitate distributed computing. The computing environment 100 may be organized in various functional levels. For example, the computing environment 100 may comprise an access layer, an aggregation/distribution layer, a core layer, or any other layer that facilitates distributed computing.

The access layer of the computing environment 100 may comprise a collection of computing devices such as, for example, servers 109. A server 109 may comprise one or more server blades, one or more a server racks, or one or more computing devices configured to implement distributed computing.

To this end, a server 109 may comprise a plurality of computing devices that may are arranged, for example, in one or more server banks, computer banks, or other arrangements. For example, the server 109 may comprise a cloud computing resource, a grid computing resource, and/or any other distributed computing arrangement. Such computing devices may be located in a single installation. A group of servers 109 may be communicatively coupled to a network switch 113. The network switch 113 may relay input data to one or more servers 109 and relay output data from one or more servers 109. A network switch 113 may comprise a router, a hub, a bridge, or any other network device that is configured to facilitate the routing of network packets.

The aggregation/distribution layer may comprise one or more network switches 113. The network switches 113 of the aggregation/distribution layer may route or otherwise relay data between the access layer. The core layer may comprise one or more network switches 113 for routing or relaying data between the aggregation/distribution layer. Furthermore, the core layer may receive inbound data from a network 117 and route the incoming data throughout the core layer. The core layer may receive outbound data from the aggregation/distribution layer and route the outbound data to the network 117. Thus, the computing environment 100 may be in communication with the network 117 such as, for example, the Internet.

The computing environment 100 may further comprise a network state monitor 121. The network state monitor 121 may comprise one or more computing devices that are communicatively coupled to one or more network switches 113 of the computing environment 100. The network state monitor 121 may be configured to execute one or more monitoring applications for generating a global snapshot of the network state of the computing environment 100.

In various embodiments, the computing environment 100 comprises a reference clock 124. The reference clock 124 may be a global clock that is implemented in accordance with a time synchronizing protocol. The various components of the computing environment 100 such as, for example, the network switches 113, may be synchronized according to the reference clock 124. In this respect, the various components of the computing environment 100 implement a time synchronizing protocol based on a reference clock 124 or any other clock.

Next, a general description of the operation of the various components of the computing environment 100 is provided. To begin, the various servers 109 may be configured to execute one or more applications or jobs in a distributed manner. The servers 109 may receive input data formatted as network packets. The network packets may be received by the server 109 from a network 117. The received network packets may be routed through one or more network switches 113 and distributed to one or more servers 109. Thus, the servers 109 may process input data that is received via the network 117 to generate output data. The output data may be formatted as network packets and transmitted to various destinations within the computing environment 100 and/or outside the computing environment 100.

As the servers 109 execute various distributed applications, the computing environment 100 may experience network traffic flowing throughout the computing environment 100. This may be a result of network packets flowing through the various network switches 113. The flow of network traffic may cause network traffic congestion in portions of the computing environment 100. For example a particular set of network switches 113 may experience significantly more network traffic congestion than other network switches 113 in the computing environment 100.

The network packets flowing through the computing environment 100 may correspond to various packet classes, packet priorities, or any other prioritization scheme. Network packets may be dropped by a network switch 113 if a buffer or queue of the network switch 113 is full or is nearing maximum capacity. Furthermore, network packets may be associated with a particular application or job executed by a server 109. This may lead to network traffic patterns in the computing environment 100, where such traffic patterns may be characterized based on packet priority, packet class, application, etc.

Each network switch 113 may receive one or more network packets. A network switch 113 may store a network packet in a packet buffer according to a buffer address. The network packet may be associated with a packet queue. The packet queue facilitates a prioritization of the network packet. A network switch 113 may further comprise a scheduler, where the scheduler determines a transmission order for the network packets. For example, the scheduler may prioritize one queue among a set of queues for transmission of the network packet. Based on various prioritization schemes and/or scheduling schemes, network packets received by a network switch 113 are routed to various destinations.

As a network switch 113 receives a relatively large influx of network packets, the packet buffer resources may be consumed. Also, various packet queues may also become heavily populated in response to the network switch 113 receiving many network packets. Individual network packets may experience packet delays throughout a routing through the network switch 113. And furthermore, the power consumption associated with portions of the network switch 113 may increase. To this end, a large influx of network packets may increase the consumption of network switch resources, where the network switch resources may be expressed in terms of memory consumption, power consumption, packet queue utilization, packet delay, or any combination thereof.

A large influx of network packets in a network switch 113 may indicate a relatively large degree of network traffic congestion associated with the network switch 113. As the network switch resources are consumed by the network traffic congestion, various network state metrics may be determined for the network switch 113. A network state metric may comprise a quantification of network traffic congestion associated with a particular network switch 113. For example, the network state metric may relate to a memory buffer capacity, the number of packets accumulated in one or more queues, a power consumption amount, a packet delay amount, or any combination thereof.

Additionally, a network switch 113 may be configured to monitor network packets that are associated with a specific packet processing context or event. A packet processing context relates to one or more conditions for handling networking packets that are processed by a network switch 113. A non-limiting example of a packet processing context includes the dropping of a network packet by the network switch 113. In this respect, dropped network packets are subject to monitoring by the network switch 113. As another non-limiting example, a packet processing context may relate to the power consumption of a network switch 113 exceeding a predefined threshold. Accordingly, those network packets that are processed by the network switch 113 while the network switch 113 is associated with a power consumption level that exceeds a predefined threshold level are subject to monitoring. As another non-limiting example, the packet processing context relates to a condition where a queue has exceeded a predefined queue length. Thus, those packets that are associated with this queue may be monitored. In this respect, the queue is nearing maximum capacity and those network packets that are to be associated with the queue may be monitored.

As another non-limiting example of a packet processing context, the monitoring of individual packets may be triggered upon the event that a packet delay exceeds a predefined threshold delay. For example, a packet delay for the packet may be measured using a time synchronization protocol and/or any information contained with the network packet such as, for example, local timestamps. Additionally, another non-limiting example of a packet processing context includes processing network packets that have a packet specific marking. A packet specific marking may be, for example, an Explicit Congestion Notification (ECN).

Moreover, another non-limiting example of a packet processing context may relate to load balancing. For example, the network switch 113 may be configured to monitor network packets in response to the event that a load imbalance among links exceeding a predefined threshold. That is to say, network packets are monitored in response to a load imbalance event/context.

As mentioned above, the various packet processing contexts/events may be used to conditionally monitoring of network packets. The various thresholds and conditions for characterizing these contexts/events may be programmed by operators/administrators. These thresholds/conditions may also be dynamically adjusted by the network switch 113.

In various embodiments, the packet processing context may relate to any network packet that is processed and/or routed via the network switch 113. In this case, the network switch 113 may employ a sampler to select a predefined proportion of network packets according to a sampling algorithm.

A network switch 113 may determine whether a packet is associated with a packet processing context. Moreover, the network switch 113 may filter out network packets unless they are associated with one or more packet characteristics. The characteristic may be an intrinsic property of the network packet. For example, the network switch 113 may filter out monitored network packets (e.g., dropped packets, etc.) unless the network packets are associated with a particular packet length, packet class, packet priority, a packet application type, packet type, or any other classification of a network packet. To this end, by filtering out network packets, the number of network packets subject to monitoring/debugging is reduced and the resources of the network switch 113 used to implement monitoring/debugging may be less constrained.

After the network switch 113 selects those network packets that are associated with particular characteristic, debug metadata may be generated for those network packets. Debug metadata may be specific to an individual network packet. Thus, each network packet that is associated with a predefined packet processing context (e.g., dropped packets, etc.) may be linked to corresponding debug metadata. Some non-limiting examples of debug metadata include a local port associated with routing the network packet via the network switch 113, a packet delay associated with routing the network packet via the network switch 113, a class of service of the network packet, a portion of data contained by the network packet, an event code that specifies a reason why the network packet was dropped by a queue (assuming that the context related to dropped packets), or any other circumstantial information surrounding the processing of the network packet. This packet specific debug metadata may be used by network administrators to monitor/debug one or more network switches 113.

In various embodiments, the network switches 113 of the computing environment 100 may implement a time synchronizing protocol, such as, but not limited to, a Precision Time Protocol (PTP), a protocol defined by IEEE 1588 or any variant thereof, a Network Time Protocol (NTP), or any combination thereof. A time synchronization protocol may utilize a reference clock 124 for coordinating a plurality of network components such as, for example, a network switch 113. To this end, the timing may be maintained for each network switch 113 in the computing environment 100. According to this timing, network state information generated by each network switch 113 may be associated with a synchronous time stamp. That is to say, a network state metric associated with a particular network switch 113 may be linked to a particular time stamp. This particular time stamp may be relative to the reference clock 124 and/or time stamps associated with other network switches 113. In various embodiments, the debug metadata comprises a synchronous time stamp for associating a network packet with the circumstances surrounding a particular packet processing context or event. For example, if the network switch is configured to monitor packets associated with a packet drop event, then the debug metadata may include a synchronous time stamp specifying the time the packet was dropped. In other embodiments, a stamp that is local with respect to a network switch 113 makes up at least a portion of the debug metadata.

Each network switch 113 may generate a network status message, where the network status message comprises a network state metric associated with the network switch 113 and/or debug metadata for network packets associated with a particular packet processing context. The network switch 113 may automatically transmit the network status message to a predetermined network state monitor 121 at predefined intervals of time or in response to predefined conditions/events. Furthermore, each network status message may include a synchronous time stamp.

The network state monitor 121 may receive a plurality of network status messages from the various network switches 113 in the computing environment 100. The network state monitor 121 may develop a snapshot of the computing environment 100 with respect to network traffic congestion in the computing environment 100. Through the use of network status messages that are synchronized through the use of synchronous time stamps, the network state monitor 121 may identify network switches 113 associated with disproportionately high or low network traffic. To this end, the network state monitor 121 may monitor network traffic throughout various portions of the computing environment 100.

Based on the global snapshot of the network state, operators/administrators may take action such as, for example, reallocate job scheduling across the various servers 109, identify sources of network traffic congestion, or make any adjustments to the distributed computing procedures employed by the servers 109.

In other embodiments, network operators/administrators may submit read requests to one or more network switches 113 to read any data stored in a capture buffer. The data stored in the capture buffer may include network switch metrics and/or debug metadata.

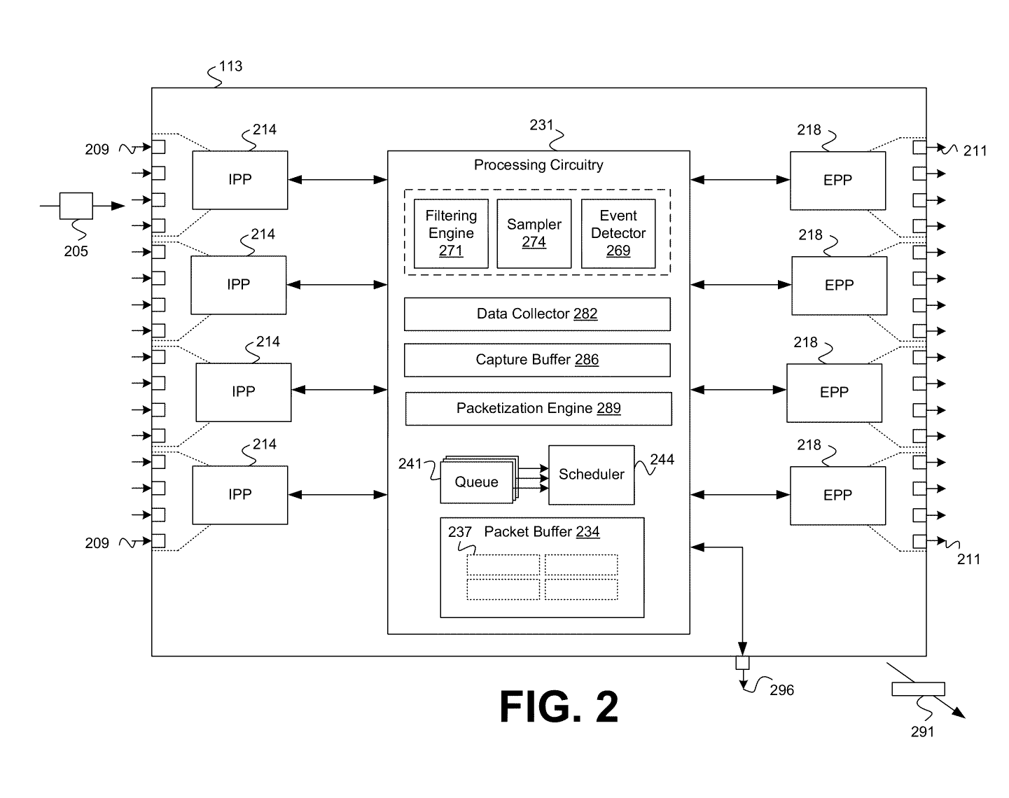

Turning now to FIG. 2, shown is a drawing of an example of a network switch 113 implemented in the computing environment 100 of FIG. 1, according to various embodiments of the present disclosure. The network switch 113 depicted in the non-limiting example of FIG. 2 may represent any network switch 113 of FIG. 1.

The network switch 113 may correspond to a switch, a router, a hub, a bridge, or any other network device that is configured to facilitate the routing of network packets. The network switch 113 is configured to receive one or more network packets 205 from a source and route these network packets to or five to one or more destinations the network switch 113 may comprise one or more input ports 209 that are configured to receive one or more network packets to under five. The network switch 113 also comprises a plurality of output ports 211. The network switch 113 performs various prioritization and/or scheduling schemes for routing a network packet 205 from one or more input ports 209 to one or more output ports 211.

The time it takes for a network packet 205 to flow through at least a portion of the network switch 113 may be referred to as a “packet delay.” Furthermore, depending on the type of network packet 205, the network packet 205 may vary in priority with respect to other network packets. By employing various prioritization/scheduling schemes, the time it takes for the network packet 205 to flow through the network switch 113 may vary from one network packet 205 to another.

The network switch 113 comprises one or more ingress packet processors 214. Each ingress packet processor 214 may be configured to be bound to a subset of input ports 209. In this sense, and ingress packet processor 214 corresponds to a respective input port set. In addition to associating an incoming packet to an input port set, the ingress packet processors 214 may be configured to process the incoming network packet 205.

A network packet 205 may be an application packet, where application packets include substantive information generated by or for an application that is executing in the computing environment 100. A network packet 205 may also be a protocol packet, where a protocol packet functions to facilitate communication via the computing environment. Non-limiting examples of protocol packets include packets that facilitate receipt, acknowledgement, or any other handshaking or security message.

The network switch 113 also comprises one or more egress packet processors 218. An egress packet processor 218 may be configured to be bound to a subset of output ports 211. In this sense, each egress packet processor 218 corresponds to a respective output port set. In addition to associating an outgoing packet to an output port set, the egress packet processors 218 may be configured to process the outgoing network packet 205.

Incoming network packets 205, such as those packets received by the input ports 209, are processed by processing circuitry 231. In various embodiments, the processing circuitry 231 is implemented as at least a portion of a microprocessor. The processing circuitry 231 may include one or more circuits, one or more processors, application specific integrated circuits, dedicated hardware, digital signal processors, microcomputers, central processing units, field programmable gate arrays, programmable logic devices, state machines, or any combination thereof. In yet other embodiments, processing circuitry 231 may include one or more software modules executable within one or more processing circuits. The processing circuitry 231 may further include memory configured to store instructions and/or code that causes the processing circuitry 231 to execute data communication functions.

In various embodiments the processing circuitry 231 may be configured to prioritize, schedule, or otherwise facilitate a routing of incoming network packets 205 to one or more output ports 211. The processing circuitry 231 receives network packets 205 from one or more ingress packet processor 214. The processing circuitry 231 performs packet scheduling and/or prioritization of received network packets 205. To this end, the processing circuitry 231 may comprise a traffic manager for managing network traffic through the network switch 113.

To execute the functionality of the processing circuitry 231, one or more packet buffers 234 may be utilized. For example, the processing circuitry 231 may comprise a packet buffer for storing network packets 205. In various embodiments, the packet buffer 234 is divided into a number of partitions 237. The packet buffer 234 is configured to absorb incoming network packets 205.

For facilitating traffic management, processing circuitry 231 may further comprise one or more packet queues 241 and one or more schedulers 244. A packet queue 241, for example, may comprise a link list of buffer addresses that reference network packets 205 stored in the packet buffer 234. In various embodiments, a packet queue 241 comprises a first in first out (FIFO) buffer of buffer addresses. As a non-limiting example, a particular packet queue 241 is accumulated such that the accumulation is expressed in terms of an amount of bytes of memory or a number of network packets 205 associated with the packet queue 241. Furthermore, each packet queue 241 may be arranged in terms of priority.

A scheduler 244 may be associated with a set of packet queues 241. The scheduler 244 may employ one or more packet prioritization/scheduling schemes for selecting a particular packet queue 241. The scheduler 244 may determine an order for transmitting a set of network packets 205 via one or more output ports 211. By transmitting network packet 205, a network packet 205 may be effectively transferred from the packet buffer 234 to one or more output ports 211.

After a network packet 205 has been processed and/or scheduled by the processing circuitry 231, the processing circuitry 231 sends the scheduled network packet 205 to one or more egress packet processors 218 for transmitting the network packet 205 via one or more output ports 211. To this end, the processing circuitry 231 is communicatively coupled to one or more ingress packet processors 214 and one or more egress packet processors 218. Although a number of ports/port sets are depicted in the example of FIG. 2, various embodiments are not so limited. Any number of ports and/port sets may be utilized by the network switch 113.

The processing circuitry 231 further comprises an event detector 269 for detecting whether a network packet 205 is associated with a particular event. That is to say, the event detector 269 is configured to determine whether network packets 205 are associated with one or more predefined packet processing contexts. For example, the event detector 269 may identify those network packets 205 that have been dropped, those network packets 205 that have been routed via the network switch 113 while the network switch 113 is in a high power consumption state, those network packets 205 that are associated with queues that have a sufficiently long queue length, or those network packets 205 that are processed during any other processing context or event. A packet processing context may relate to conditions of a network switch 113 that warrant monitoring/debugging (e.g., high traffic flow, high power consumption, etc.). The event detector 269 may analyze various components of a network packet such as, for example, headers, control bits, flags, or another component of the network packet 205.

The processing circuitry 231 may comprise a filtering engine 271 to identify and select those network packets 205 that are associated with a particular packet characteristic. In the case of a packet drop event, for those network packets that have been dropped, the filtering engine 271 may be configured to filter out low priority network packets 205. To this end, higher priority dropped packets remain and are subject to monitoring/debugging. To effectuate filtering, the filtering engine 271 may analyze various components of a network packet 205 such as, for example, headers, control bits, flags, or another component of the network packet 205. In various embodiments, filtering may occur before or after a determination is made whether a network packet is associated with a particular packet processing context/event.

The event detector 269 may comprise a sampler 274 to select a predefined proportion of network packets 205 for processing by the filtering engine 271. For example, the sampler 274 may be configured to selected 1 out of 300 packets that have been filtered by the filtering engine 271. In this regard, the sampler may reduce the amount of network packets 205 that are subject to monitoring/debugging. In various embodiments, the sampler 274 may perform sampling before filtering. In this case where dropped packets are subject to monitoring/debugging, the sampler 274 selects a predefined proportion of dropped packets to be filtered.

In other embodiments, the sampler 274 is configured to perform sampling after network packets 205 have been filtered. In this case where dropped packets are subject to monitoring/debugging, the sampler 274 samples those dropped packets that have been filtered according to a particular packet characteristic.

The processing circuitry may further comprise a data collector 282. According to various embodiments, the data collector 282 determines debug metadata for a network packet 205 in response to the network packet 205 being associated with a particular packet processing context. Once a network packet 205 is determined to be associated with a particular event or packet processing context and that network packet 205 has be subject to filtering and/or sampling, the data collector 282 determines packet specific debug metadata for the network packet. The packet specific debug metadata may assist network administrators in gaining insight about the packet with respect to the packet processing context or event. That is to say, the debug metadata may relate to circumstances surrounding the manner in which the packet was handled by the network switch 113 in relation to a particular context or event.

The debug metadata may comprise a local port such as an input port 209 or output port 211 associated with routing the network packet 205 via the network switch 113. Local port information may also include port sets. As another example, debug metadata may include a packet delay associated with routing the network packet 205 via the network switch 113. A packet delay may be calculated based on a difference in time stamps assigned to the network packet 205. Debug metadata may also include a class of service of the network packet 205 or a portion of data contained by the network packet 205, such as a number of bits of the network packet 205. The debug metadata may also comprise an event code. An event code may be an identifier that corresponds to a reason why a network packet 205 was handled according to a predefined packet processing context. For example, if the packet processing context relates to a packet drop event, the event code may specify a reason as to why the network packet 205 was dropped. In this case, one reason, among others, is that the packet was dropped because a queue was full. This circumstance may correspond to an event code.

In addition to determining packet specific debug metadata on a per packet basis, the data collector 282 may also determine one or more network state metrics associated with the network switch 113. A network state metric may comprise the instant state of the network switch 113 with respect to the packet buffer 234, one or more packet queues 241, a packet delay, a power consumption by portions of the network switch 113, or any combination thereof. To this end, a network state metric is determined based at least upon a routing of a plurality of network packets 205 via the network switch 113. The network state metric may provide a snapshot of the network switch 113 that expresses buffer usage in terms of a queue, a port, a pool, or a total buffer usage. The view of buffer usage may be an ingress view, an egress view, or a combination thereof.

The processing circuitry 231 further comprises a capture buffer 286. The capture buffer 286 is configured to store debug metadata and/or network state metrics. According to various embodiments, the capture buffer 286 is configured to operate in a persistent mode where debug metadata and/or network state metrics may be written to the capture buffer 286 until the capture buffer is full. Thereafter, additional data is written to the capture buffer while old data is ejected from the capture buffer 286 to make room for the additional data. In various embodiments, the network switch 113 receives a read request from a user to read data from the capture buffer 286.

In other embodiments, the processing circuitry 231 comprises a packetization engine 289. The packetization engine 289 is configured to aggregate portions of the debug metadata and/or network state metrics into a network status message 291. This network status message 291 may be packetized as a network status packet. The network status packet may be transmitted to the user, as discussed in further detail below.

In various embodiments, the network status message 291 is configured to be transmitted via one or more output ports 211. In this respect, the network status message 291 may be treated like a network packet 205 that is routed out of the network switch 113. Thus, the network status message 291 may be encoded in a format used by a network packet 205.

In various embodiments, the network status message 291 is configured to be transmitted via a dedicated network status message port 296. In this case, the dedicated network status message port 296 does not output network packets 205. In various embodiments, the dedicated network status message port 296 may be directly coupled to a network state monitor 121 (FIG. 1) to facilitate direct communication between the network switch 113 and the network state monitor 121.

Next, a general description of the operation of the various components of the network switch 113 is provided. To begin, the network switch 113 schedules/prioritizes various network packets 205 that are received by the network switch 113. As the rate at which network packets 205 arrive at the network switch 113 varies over time, the resources of the network switch 113 may be consumed. For example, the packet buffer 234 may be filled such that the available capacity of the packet buffer 234 is reduced. As another example, one or more packet queues 241 may be accumulated with an increased number of network packets 205 received at the network switch 113. Even further, the power consumption of portions of the network switch 113 may increase in proportion to the network traffic associated with the network switch 113. Also, the packet delay associated with each network packet 205 may increase as the network switch 113 handles an increased amount of network traffic.

The data collector 282 may generate one or more network state metrics that quantify the degree of network traffic congestion associated with the network switch 113. In various embodiments, the network state metric may be directed to a degree of use of the packet buffer 234. For example, the network state metric may relate to an amount of free space or available capacity in the packet buffer 234, a percentage or proportion of use of the packet buffer 234, the amount of data in the packet buffer 234, or any combination thereof. The network state metric may be directed to a particular partition 237 of the packet buffer 234, a particular group of partitions 237, or the total packet buffer 234.

In other embodiments, the network state metric may relate to a headroom fill level associated with the packet buffer 234 or particular partitions 237 of the packet buffer 234. A headroom fill level may be, for example, a cutoff amount associated with an amount of data that may be transmitted to the packet buffer 234 for storing. If it is the case that the headroom fill level is 90% of the packet buffer 234, then the packet buffer 234 initiates an instruction to prevent or otherwise terminate subsequent write operations to the packet buffer 234 when the packet buffer 234 is filled to 90%. Upon initiating the instruction, the packet buffer 234 may continue to receive packet data until the instruction is implemented. That is to say, the instruction to terminate subsequent write operations may take a finite amount of time before the instruction is implemented. To this end, the packet buffer 234 may be filled with an amount of data causing an excess 90% of the packet buffer 234 to be used. Thus, the headroom fill level of the packet buffer 234 provides headroom to the packet buffer 234 for absorbing additional data beyond a cutoff point.

The headroom fill level may be sets according to a worst-case scenario. The worst-case scenario, for example, may relate to an amount of data that may be written to a packet buffer 234 between the time the termination instruction is issued and the time that the termination instruction is implemented. In various embodiments, the headroom fill level may be adjusted by the processing circuitry 231.

The network state metric may also be directed to a degree of use of one or more packet queues 241, according to various embodiments. For example, a number of packets accumulated in a particular packet queue 241 or the amount of memory accumulated in the particular packet queue 241 may be used as a basis for generating a network state metric. The network state metric may relate to the use of a particular packet queue 241 or a group of packet queues 241. Accordingly, the network state metric may indicate the degree in which a group of packet queues 241 is accumulated.

In various embodiments, the network state metric is directed to a power consumption of portions of the network switch 113. For example, the network switch 113 may quantify a power consumption associated with particular portions of the network switch 113 such as, for example, the processing circuitry 231. As network traffic congestion through the network switch 113 increases, portions of the network switch 113 may realize a relatively large degree of power consumption. Accordingly, a network state metric may reflect the degree of power consumption associated with particular portions of the network switch 113.

The network state metric may also relate to a packet delay of a group of packets, according to various embodiments. A packet delay may be measured or otherwise determined by the network switch 113 for each network packet 205 that passes through the network switch 113. For example, the network switch 113 may attach an inbound time stamp to a network packet 205 upon receipt of the network packet 205. When the network packet 205 is to be transmitted via one or more output ports 211 of the network switch 113, a packet delay may be measured based on the inbound time stamp. To this end, the inbound time stamp indicates a timing that is local with respect to the network switch 113. Accordingly, the network state metric may be based at least upon an average packet delay associated with a group of network packets 205 received by the network switch 113.

The group of network packets 205 may be, for example, network packets associated with a particular application type, a particular application, a particular packet class, or any other classification of network packets 205. An application or application type may be determined based on an association of a network packet 205 to a particular application identifier. That is to say, network packets 205 may comprise an application identifier for determining an application or application type associated with the network packet 205. Thus, the network state metric may indicate a packet delay associated with network packets 205 of a particular application. The network state metric may also indicate a proportion of the packet buffer 234 and/or proportion of a partition 237 of the packet buffer 234 that is consumed by network packets 205 of particular application. Furthermore, the network state metric may indicates a number of packet queues 241 or proportion of packet queues 241 that are consumed by network packets 205 of a particular application.

In addition to obtaining a network state metric, the network switch 113 may identify a synchronous time stamp associated with the network state metric. The network state metric may reflect the network traffic congestion of the network switch 113 for a particular period of time. Based at least upon this particular period of time, a synchronous time stamp may be associated with the network state metric. The synchronous time stamp may be identified by the network switch 113 in accordance with a time synchronization protocol. Each of the network switches 113 in a computing environment 100 (FIG. 1) may be synchronized according to a reference clock 124 (FIG. 1). By using a time synchronization protocol, a network switch 113 may identify a time stamp that relates to other network switches 113 in the computing environment. That is to say, each network switch 113 in the computing environment 100 may identify respective time stamps in a synchronous manner.

In addition to determining network state metrics, the data collector 282 may also determine debug metadata that is packet specific for individual network packets 205, according to various embodiments. For example, the processing circuitry 231 may use any or a combination of the event detector 269, the filtering engine 271, and the sampler 274 to identify those network packets 205 that an administer wishes to monitor/debug. For example, if an administrator wishes to monitor application packets for a particular application that have been dropped, then the event detector 269 may identify those network packets 205 that have been dropped in response to a drop event. The filtering engine 271 may then restrict the dropped network packets to those application packets associated with a particular application. Furthermore, the sampler 274 may select a predefined proportion of network packets 205 before or after filtering and/or event detection. To this end, the quantity of network packets 205 that are subject to monitoring/debugging is reduced by the sampler 274. This may result in a reduction in an amount of debug metadata stored by the capture buffer 286.

Debug metadata is generated for those network packets 205 that have been filtered/restricted by the filtering engine 271, sampled by the sampler 274, and/or linked to a particular event or packet processing context by the event detector 269. This debug metadata is written to the capture buffer 286. Thus, the capture buffer 286 may include a combination of debug metadata on a per packet basis as well as one or more network state metrics.

In some embodiments, an administrator submits read requests to read at least a portion of the capture buffer 286. For example, the administrator may submit search queries to access particular data to assist in a debugging process. In this respect, the administrator may attempt to understand the circumstances behind the network switch performance in response to different events or processing contexts.

In other embodiments, a packetization engine 289 generates a network status message 291, where the network status message 291 includes debug metadata and/or one or more network state metrics. In some embodiments, the network status message 291 includes a synchronous time stamp associated with at least the network state metrics. Moreover, the packetization engine 289 may transmit the network status message 291 to a predetermined network state monitor 121 (FIG. 1). The network status message 291 may be transmitted via an output port 211 or a dedicated network status message port 296.

In various embodiments of the present disclosure, the packetization engine 289 generates a network status message 291 at periodic intervals of time. To this end, a network state monitor 121 receives debug data and/or network state metrics for each network switch 113 at periodic intervals of time.

In alternative embodiments, the packetization engine 289 generates the network status message 291 in response to a network state metric exceeding or falling below a predetermined threshold amount. For example if the network state metric relates to an available packet buffer capacity, the packetization engine 289 may generate a network status message 291 in response to the available packet buffer capacity falling below a predetermined amount of capacity. As another example, if the network state metric relates to a packet delay for a particular application, then the packetization engine 289 may generate a network status message 291 in response to the packet delay exceeding a predetermined threshold delay.

In the case where the processing circuitry 231 is configured to monitor multiple events/contexts (e.g., packets received while the switch is in a higher power state, packets that have been dropped, etc.), a network status message 291 dedicated to each context may be generated and sent to corresponding network state monitors 121. For example, a first network state monitor 121 may receive debug data and/or network state metrics associated with power consumption while a second network state monitor 121 may receive debug data and/or network state metrics associated with dropped packets.

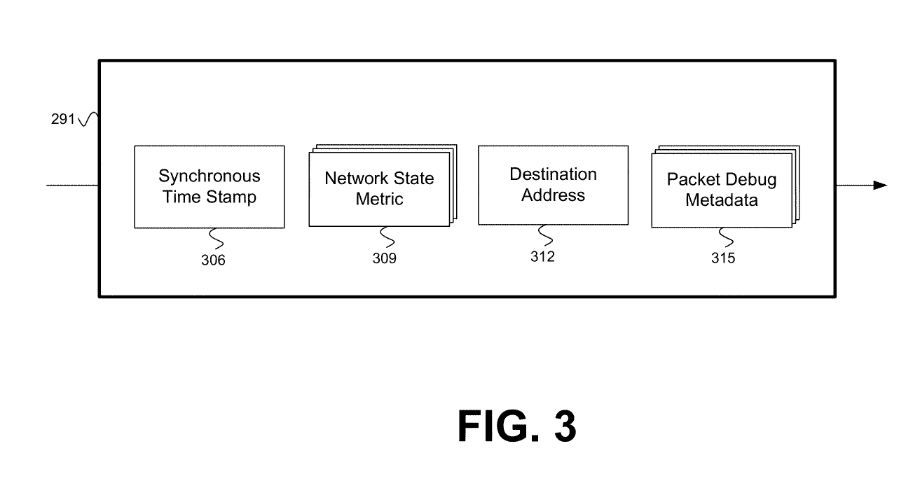

Moving to FIG. 3, shown is a drawing of an example of a network status message 291 generated by a network switch 113 in the computing environment 100 of FIG. 1, according to various embodiments of the present disclosure. FIG. 3 provides a non-limiting example of a network status message 291 that may be encoded as a network packet for transmission in a computing environment 100. In this respect, the network status message 291 is a network status packet.

In various embodiments, the network status message 291 comprises a synchronous time stamp 306, one or more network state metrics 309, a destination address 312, and/or packet specific debug metadata 315. The synchronous time stamp 306 is generated in accordance with a time synchronization protocol implemented by each network switch 113 in the computing environment 100. The synchronous time stamp 306 may represent a period of time associated with the network state metrics 309 included in the network status message 291. For example, the network state metrics 309 may reflect a current network traffic congestion. As the network traffic congestion changes over time, updated network state metrics 309 may be obtained by the network switch 113. Accordingly, new synchronous time stamps may be identified for the updated network state metrics 309. The new synchronous time stamp and the updated network state metrics 309 may be included in an updated network status message.

In various embodiments, a destination address 312 is included in the network status message 291. The destination address 312 may reference a network state monitor 121 (FIG. 1). Thus, the network status message 291 may be transmitted to the network state monitor 121 directly or through a series of network switches 113.

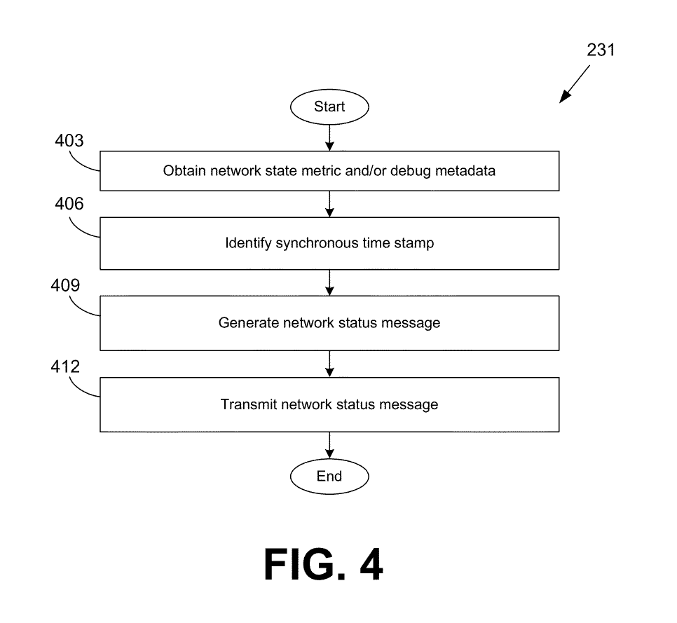

Turning now to FIG. 4, shown is a flowchart that provides one example of the operation of a portion of the logic executed by the processing circuitry 231, according to various embodiments. It is understood that the flowchart of FIG. 4 provides merely an example of the many different types of functional arrangements that may be employed to implement the operation of the portion of the logic executed by the processing circuitry 231 as described herein. As an alternative, the flowchart of FIG. 4 may be viewed as depicting an example of steps of a method implemented in the processing circuitry 231 according to one or more embodiments. Specifically, FIG. 4 provides a non-limiting example of automatically transmitting network status messages 291 (FIG. 2) by a network switch 113 (FIG. 1).

The processing circuitry 231 obtains a network state metric 309 (FIG. 3) and/or debug metadata 315 (FIG. 3) (403). The network state metric 309 may quantify network traffic congestion associated with a particular network switch 113. The processing circuitry 231 may implement a data collector 282 (FIG. 2) for obtaining the network state metric 309.

The network state metric 309 may be based at least upon a network packet 205 (FIG. 2). In this case, the processing circuitry 231 determines a delay for the network packet 205 that is routed via a network switch 113. The network state metric 309 may be determined based at least upon the delay. The delay may be a packet delay that is associated with a particular group of network packets 205. The group of network packets may be associated with a packet class, an application type, an application, or any other classification of a packet. In this respect, and average packet delay may be determined for the group of network packets 205. Furthermore, the packet delay may be determined based at least upon a network switch time stamp that is local with respect to the network switch 113. When determining a packet delay for a particular application, the processing circuitry 231 may associate a set of network packets 205 to an application based at least upon a corresponding packet identifier associated with each of the network packets 205.

In various embodiments, the network state metric 309 indicates a memory capacity associated with a packet buffer 234 (FIG. 2) of the network switch 113. For example, the memory capacity may be expressed as a percentage of use, an amount of free space, a proportion of use, an amount of use, or any other indicator of expressing a remaining memory capacity. Furthermore, the network state metric 309 may be directed to a particular packet buffer partition 237 (FIG. 2) or a group of packet buffer partitions 237. That is to say, the memory capacity may be expressed on a per partition basis, a per partition group basis, or a total buffer basis. In various embodiments, the network state metric 309 comprises a headroom level associated with a packet buffer 234, a packet buffer partition 237, or a group of packet buffer partitions 237. The headroom level may indicate a limit of the quantity of packets that are to be written in the packet buffer 234.

In various embodiments the network state metric 309 is based at least upon a quantity of packets or an amount of memory accumulated in a packet queue 241 (FIG. 2) or a group of packet queues 241. The network state metric 309 may also be based at least upon the power consumption associated with a portion of the network switch 113.

With respect to debug metadata 315, the debug metadata 315 may include metadata corresponding to a respective network packet 205 that is subject to monitoring/debugging. The debug metadata 315 may relate to the circumstances surround the processing of a packet for a given event or context. For example, the debug metadata 315 for an individual packet may be a time stamp, a packet delay, internal port identifiers, event codes, actual packet data contained by the network packet 205 or any other circumstantial information associated with the individual network packet 205. The type of debug metadata 315 may be tailored to address a particular event or packet processing context that is subject to monitoring/debugging.

The processing circuitry 231 identifies a synchronous time stamp 306 (FIG. 3) (406). For example, the network switch 113 may obtain reference clock data associated with a reference clock 124 (FIG. 1). The reference clock 124 may synchronize a set of network switches 113 such that each network switch provides time stamps that are synchronous with respect to one another. Based on the reference clock data, the processing circuitry 231 may determine a synchronous time stamp 306. The synchronous time stamp 306 is associated with the network state metric 309.

In various embodiments, each network switch 113 in a computing environment 100 implements a time synchronization protocol for generating synchronous time stamps. Thus, a particular network switch 113 may generate a synchronous time stamp 306 that represents a period of time for which the network state metric 309 is obtained.

The processing circuitry 231 generates a network status message 291 (409). The network status message 291 may be formatted as a packet that is packetized by a packetization engine 289 (FIG. 2). The network status message 291 may comprise the network state metric 309 and a corresponding synchronous time stamp 306.

The processing circuitry 231 transmits the network status message 291 (412). The network status message 291 may be transmitted to a monitoring system such as, for example, the network state monitor 121 of FIG. 1. In this respect, the network state monitor 121 is a predetermined destination that is configured to receive network status messages 291 from multiple network switches 113.

In various embodiments, the processing circuitry 231 transmits a plurality of network status messages 291 according to a periodic time interval such that each network status message 291 represents a respective instance of network traffic congestion associated with particular network switch 113. The periodic transmission interval of the network status message 291 may be adjusted by an operator/administer.

In alternative embodiments, the processing circuitry 231 is configured to transmit the network status message 291 to the predetermined monitoring system in response to comparing the network state metric 309 to a predetermined threshold value. In this respect, the network status message 291 is transmitted in response to a network state metric 309 exceeding or falling below a predetermined threshold value.

In various embodiments, the processing circuitry 231 may designate a predetermined packet priority to the network status message 291. In this respect, the network status message 291 may be received by other network components and prioritized with respect to network packets 205. That is to say, a network switch 113 may receive the network status message 291 of another network switch 113 along with one or more network packets 205. This network switch 113 may prioritize the network status message 291 based at least upon the predetermined packet priority.

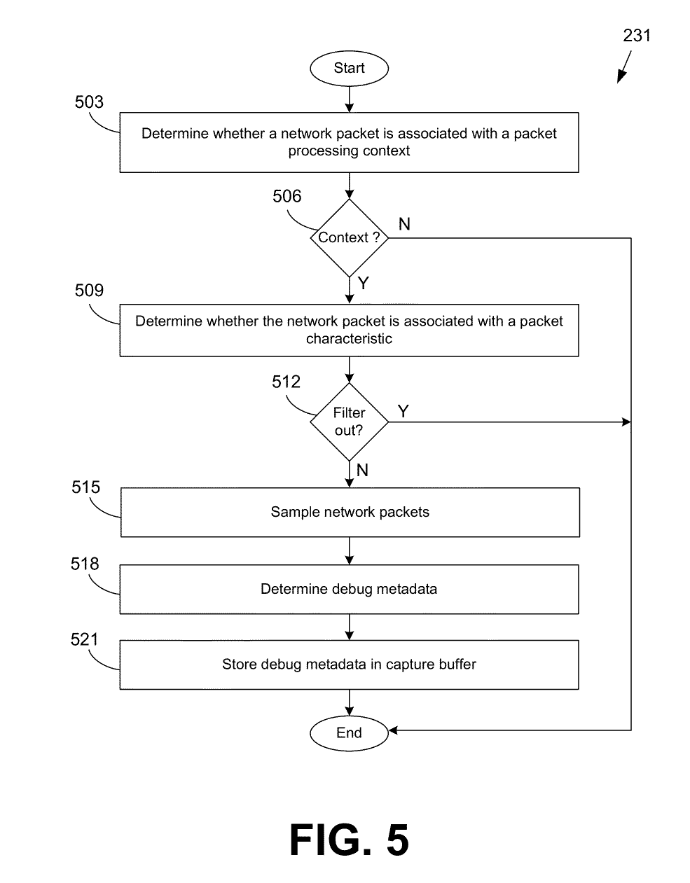

Turning now to FIG. 5, shown is a flowchart that provides another example of operation of a portion of the logic executed by the processing circuitry 231, according to various embodiments. It is understood that the flowchart of FIG. 5 provides merely an example of the many different types of functional arrangements that may be employed to implement the operation of the portion of the logic executed by the processing circuitry 231 as described herein. As an alternative, the flowchart of FIG. 5 may be viewed as depicting an example of steps of a method implemented in the processing circuitry 231 according to one or more embodiments. Specifically, FIG. 5 provides a non-limiting example of capturing packet specific debug metadata 315 (FIG. 3) in a network switch 113 (FIG. 1).

The processing circuitry 231 determines whether a network packet 205 (FIG. 2) is associated with a packet processing context (503). The processing circuitry 231 may comprise an event detector 269 (FIG. 2) for identifying the occurrence of packet processing events/contexts and those network packets 205 that are associated with the packet processing events/contexts. For example, the event detector 269 may identify those network packets 205 that associated with events/contexts such as, for example, packet dropping events, sufficiently long queues, high power consumption, etc.

If a network packet 205 is not associated with a particular packet processing context (506) then the operation ends. Next, the processing circuitry 231 determines whether the network packet 205 is associated with a packet characteristic (509). For example, the processing circuitry 231 may employ a filtering engine 271 (FIG. 2) to restrict monitoring/debugging only to those network packets 205 with a particular packet characteristic. A packet characteristic may be an intrinsic property or attribute of the network packet 205. The filtering engine 271 effectively reduces a search range for those network packets 205 that an administrator is interested in monitoring/debugging. If a network packet 205 is not associated with a particular packet characteristic (512) the network packet 205 is filtered out and the operation ends.

Next, the processing circuitry 231 samples the network packets 205 (515). For example, the processing circuitry 231 may employ a sampler 274 (FIG. 2) to select a predefined proportion of network packets. For example, the sampler 274 may select every other packet or 1 out of every 100 packets. Thus, the sampler 274 indiscriminately reduces the quantity of network packets 205 that are subject to monitoring/debugging.

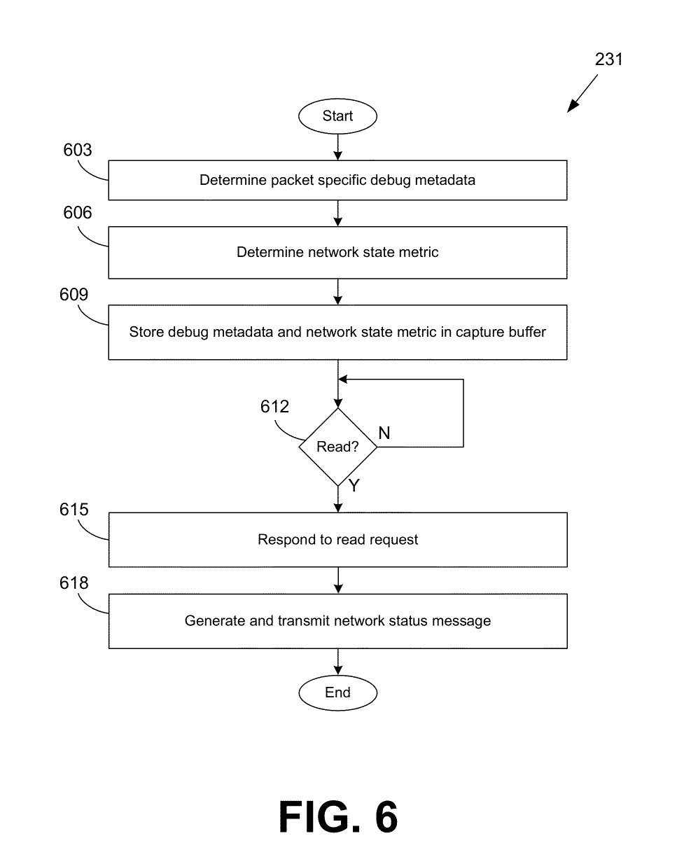

The processing circuitry 231 determines debug metadata 315 (FIG. 3) for the network packet 205 (518). Once the processing circuitry 231 has determined that a particular network packet 205 is associated with a packet processing context/event and is associated with a packet characteristic, the processing circuitry 231 may employ a data collector 282 (FIG. 2) to determine debug metadata 315 for the network packet 205. Thereafter, the processing circuitry 231 may store the debug metadata 315 in a capture buffer 286 (FIG. 2) (521). Debug metadata 315 accumulates in the capture buffer 286. This information may be shared with an administrator, as discussed in further detail with respect to at least FIG. 6. Data may be written into the capture buffer 286 until the capture buffer 286 is full. Alternatively, the capture buffer 286 may be a circular buffer where old data is ejected to make room for new data.

Referring next to FIG. 6, shown is a flowchart that provides one example of another operation of a portion of the logic executed by the processing circuitry 231, according to various embodiments. It is understood that the flowchart of FIG. 6 provides merely an example of the many different types of functional arrangements that may be employed to implement the operation of the portion of the logic executed by the processing circuitry 231 as described herein. As an alternative, the flowchart of FIG. 6 may be viewed as depicting an example of steps of a method implemented in the processing circuitry 231 according to one or more embodiments. Specifically, FIG. 6 provides a non-limiting example of sharing data stored in a capture buffer 286 (FIG. 2) with an administrator.

To begin, the processing circuitry 231 determines packet specific debug metadata 315 (FIG. 3) (603). For example, the processing circuitry 231 may employ functionality discussed with respect to at least FIG. 5. The processing circuitry 231 may determine a network state metric 309 (FIG. 3) (606). The processing circuitry 231 stores the debug metadata 315 and network state metric 309 in the capture buffer 286 (609).

According to some embodiments, the processing circuitry waits for a read request (612). For example, an administrator may submit a read request to the network switch 113 (FIG. 1) that implements the processing circuitry 231. Once a read request is received, the processing circuitry 231 responds to the read request (615). The read request may comprise a search query for accessing data stored in the capture buffer 286. The read request response may comprise one or more electronic messages that contain the portions of the data stored in the capture buffer 286.

In some embodiments, the processing circuitry 231 generates and transmits a network status message 291 (FIG. 2) (618). The generation and transmission may be performed automatically without being responsive to a read request. For example, the processing circuitry 231 may employ the functionality discussed with respect to at least FIG. 4. The processing circuitry 231 may comprise a packetization engine 289 (FIG. 2) for automatically generating network status packets to the administrator.

The processing circuitry 231 and other various systems described herein may be embodied in software or code executed by general purpose hardware. As an alternative, the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc.

The flowcharts of FIGS. 4-6 show the functionality and operation of an implementation of portions of the processing circuitry 231 implemented in a network switch 113 (FIG. 2). If embodied in software, each reference number, represented as a block, may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts of FIGS. 4-6 a specific order of execution, it is understood that the order of execution may differ from that which is depicted. For example, the order of execution of two or more blocks may be scrambled relative to the order shown. Specifically, with respect to FIG. 5, event detection, filtering, and sampling of a network packet may be performed in any order.

Also, two or more blocks shown in succession in FIGS. 4-6 may be executed concurrently or with partial concurrence. Further, in some embodiments, one or more of the blocks shown in FIGS. 4-6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the processing circuitry 231, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A system comprising:
processing circuitry implemented in a switch, the processing circuitry being configured to:
determine whether a network packet has been dropped by a queue associated with the switch;
determine whether the network packet is associated with a packet characteristic that is intrinsic to the network packet;
determine debug metadata for the network packet to facilitate a debugging of the switch; and
store the debug metadata in a memory associated with the switch.

2. The system of claim 1, wherein the packet characteristic is at least one of a packet length, a packet class, a packet priority, or a packet application type.

3. The system of claim 1, wherein the processing circuitry that is configured to determine whether the network packet is associated with a packet characteristic is further configured to determine whether the network packet is generated by a network application.

4. The system of claim 1, wherein the debug metadata is at least one of a local port associated with routing the network packet via the switch, a packet delay associated with routing the network packet via the switch, a class of service of the network packet, a portion of data contained by the network packet, or an event code that specifies a reason why the network packet was dropped by the queue.

5. The system of claim 4, wherein one of a plurality of event codes specifies a buffer full event.

6. A switch comprising:
an event detector configured to determine whether a network packet is associated with a packet processing event;
a filtering engine configured to determine whether the network packet is associated with a packet characteristic;
a data collector configured to determine debug metadata in response to the network packet being associated with the packet characteristic and being associated with the packet processing context; and
a capture buffer configured to store the debug metadata.

7. The switch of claim 6, wherein the packet processing event comprises a corresponding queue exceeding a predefined queue length.

8. The switch of claim 6, wherein the packet processing event comprises a power consumption level of the switch exceeding a predefined threshold level.

9. The switch of claim 6, wherein the packet processing event comprises a packet delay associated with the network packet exceeding a time based threshold.

10. The switch of claim 9, wherein the packet delay is based at least upon a time stamp associated with the network packet, wherein the time stamp is at least one of a local time stamp that is local with respect to the switch or a synchronized time stamp that is synchronized with respect to a plurality of switches.

11. The switch of claim 6, wherein the switch further comprises a sampler configured to select a predefined proportion of a plurality of network packets received by the switch, thereby causing a reduction in an amount of debug metadata stored by the capture buffer.

12. The switch of claim 6, wherein the debug metadata is at least one of a local port associated with routing the network packet via the switch, a packet delay associated with routing the network packet via the switch, a class of service of the network packet, a portion of data contained by the network packet, or an event code for the network packet.

13. The switch of claim 6, further comprising a packetization engine configured to aggregate at least a portion of the debug metadata stored in the capture buffer into a network status packet, the packetization engine being further configured to transmit the network status packet to a user.

14. The switch of claim 6, wherein the capture buffer is configured to respond to a read request by allowing a user to read at least a portion of the debug metadata from the capture buffer.

15. A method comprising:
determining whether a network packet is associated with a packet processing context, the packet processing context specifying a condition of handling the network packet processed in a switch;
determining debug metadata for the network packet in response to the network packet being associated with the packet processing context; and
storing the debug metadata in a capture buffer.

16. The method of claim 15, further comprising filtering the network packet according to a packet characteristic, thereby causing a reduction in an amount of debug metadata stored by the capture buffer.

17. The method of claim 15, wherein the packet processing context comprises a dropped packet event.

18. The method of claim 15, further comprising transmitting a network status message to a user, the network status message comprising the debug metadata.

19. The method of claim 18, wherein the network status message further comprises a network state metric, the network state metric being determined based at least upon a routing of a plurality of network packets via the switch.

20. The method of claim 15, wherein the debug metadata is at least one of a local port associated with routing the network packet via the switch, a packet delay associated with routing the network packet via the switch, a class of service of the network packet, a portion of data contained by the network packet, or an event code for the network packet.
